(19) United States
(12) Patent Application Publication
(10) Pub. No.: US 2024/0269800 A1
(43) Pub. Date: Aug. 15, 2024

(54) A TOOL WEAR INDICATOR FOR CONCRETE SURFACE PROCESSING EQUIPMENT

(71) Applicant: HUSQVARNA AB, Huskvarna (SE)

(72) Inventors: Tomas Torvaldsson, Soderkoping (SE); Viktor Laursen, Linghem (SE); Linus Ottosson, Norsholm (SE); Daniel Gustavsson, Soderkoping (SE)

(21) Appl. No.: 18/560,194

(22) PCT Filed: Apr. 25, 2022
(86) PCT No.: PCT/SE2022/050396

§ 371 Date: Nov. 10, 2023

(30) Foreign Application Priority Data
May 12, 2021 (SE) 2150601-9

(51) Int. Cl. B24B 49/12; B24B 7/18; B24B 55/05

(52) U.S. Cl. CPC B24B 49/12; B24B 7/186; B24B 55/052

(57) ABSTRACT

A floor grinder (100) for processing a concrete surface (101), the floor grinder comprising one or more rotatable abrasive tool holders (150) arranged in a plane (P) to hold respective abrasive tools (210, 510), at least one power source (110, 120) arranged to drive the tool holders (150), a cover body (130) fixedly arranged in relation to the plane (P), and a dust skirt (140) movably attached around a rim of the cover body (130) to engage the concrete surface (101) during floor grinding operation, where the floor grinder (100) comprises at least one tool wear indicator (160) configured to indicate a current tool wear based on a displacement of the dust skirt (140) relative to the cover body (130) in a direction (D) normal to the plane (P).

### TECHNICAL FIELD

The present disclosure relates to floor grinders for processing concrete surfaces. There are disclosed techniques and devices for indicating a current wear level of an abrasive surface processing tool.

### BACKGROUND

Concrete surfaces are commonly used for flooring in both domestic and industrial facilities. The size of concrete surface floors ranges from a few square meters for a domestic garage floor to thousands of square meters in larger industrial facilities. Concrete surfaces offer a cost efficient and durable flooring alternative and have therefore gained popularity over recent years.

A floor grinder can be used to efficiently process a concrete surface in order to, e.g., obtain a level surface having a uniform topology and/or a surface having a desired surface texture. Floor grinders can also be used to polish concrete surface in order to obtain a glossy surface finish. Concrete surface processing is normally performed in steps, where abrasive tools of decreasing grit size, i.e., finer, and finer grit, are used in sequence to first obtain an efficient removal of material and then a smooth concrete surface.

The abrasive tools are subject to wear as the concrete surface is processed, and therefore regularly needs to be replaced by new abrasive tools. It is important that the abrasive tools are replaced in time before the tool holder comes into contact with the concrete surface, which may cause damage to both machine and concrete surface. The operator therefore regularly needs to inspect the abrasive tools in order to determine the current tool wear level.

These frequent inspections are inconvenient and takes time.

EP0514822 discloses an abrasive tool where a visible marking is sintered into a surface of the cutting body. This marking allows an operator to determine tool wear more conveniently. However, the operator still needs to tilt the floor grinder to visually inspect the tools.

US2017312884 relates to a floor grinding machine in which information about the wear of the tools is automatically provided to the operator's console from measuring members arranged in connection to the tools, thereby allowing the operator to determine tool wear directly on the console. However, there is a need for less complicated systems which can be implemented at reduced cost.

### SUMMARY

It is an object of the present disclosure to provide improved wear indicators for abrasive tools as well as systems for abrasive tool wear indication.

This object is obtained by a floor grinder for processing a concrete surface. The floor grinder comprises one or more rotatable abrasive tool holders arranged in a plane to hold respective abrasive tools, at least one power source arranged to drive the tool holders, a cover body fixedly arranged in relation to the plane, and a dust skirt movably attached around a rim of the cover body to engage the concrete surface during floor grinding operation. The floor grinder also comprises at least one tool wear indicator configured to indicate a current tool wear based on a displacement of the dust skirt relative to the cover body in a direction normal to the plane.

The tool wear indicator can be realized in a particularly cost-efficient manner, e.g., as an adhesive sticker having a dimension corresponding to the abrasive tools. More advanced tool wear indicators can also be configured in this manner, such as mechanical devices configured to indicate tool wear, and also electronic tool wear indicators. Thus, advantageously, the operator of the floor grinder does not have to tilt the machine frequently in order to inspect the status of the abrasive tools, since the tool wear can be determined without directly inspecting the abrasive tools.

Versions of the tool wear indicators discussed herein can be configured to indicate how much of the tools mounted onto the floor grinder which remain, and/or how much of the tools that have been spent during operation. Some of the tool wear indicators can also be used to trigger alarms and even prevent floor grinding operation when the tool approach dangerous wear levels.

According to aspects, the dust skirt is external to the cover body, where the at least one tool wear indicator is a visual marker attached to the cover body, where the visual marker is arranged to be traversed and gradually concealed by the dust skirt during displacement of the dust skirt normal to the plane. One example realization of this type of visual marker is a normal sticker, which is a very cost effective tool wear indicator that is still reliable. The sticker can be configured to have a height measured normal to the plane that is matched to a corresponding height of an abrasive segment. Alternatively, the sticker may comprise visual markings indicating current tool wear. The tool wear indicator may furthermore comprise a visual identifier indicative of an abrasive tool type associated with the tool wear indicator. This allows the operator to more easily select the correct tool wear indicator, i.e., the one that corresponds to the abrasive tool or tools currently in use. A rod or other form of elongated object comprising some form of markings can also be used. If the rod is slidably held in a holder fixed to the cover body and contacts the dust skirt, then it will rise up through the holder as the tools wear down. The operator of the floor grinder can then determine tool wear state by visual inspection of the rod, i.e., see how far the rod has risen up through the holder due to relative movement between cover body and dust skirt.

According to other aspects, the tool wear indicator comprises a linear position sensor, and the floor grinder comprises a control unit arranged to receive an output signal from the linear position sensor, and to determine a current tool wear based on the output signal from the linear position sensor. This implementation is slightly more advanced, although the linear position sensor can be obtained at reasonable cost. The automated tool wear indicator arrangement represents a reliable and cost efficient system for tool wear indication which voids the need for the operator to manually inspect the abrasive tools regularly. Many different types of linear position sensors can be used in this context. For instance, the linear position sensor can be any of a capacitive displacement sensor, a Hall effect sensor, and inductive sensor, a linear variable differential transformer, a photodiode array, and a linear mechanical encoder.

The linear position sensor may also comprise some form of distance sensor, such as a laser distance sensor or an inductive distance sensor. This distance sensor can be used to measure relative displacement between cover body and dust skirt, which relative displacement is indicative of tool wear.

The control unit is optionally arranged to determine a current tool wear rate based on the output signal from the linear position sensor and on a time reference. The tool wear rate can be used for things such as determining an estimated time to next tool shift.

According to some aspects, the control unit is arranged to average, or low-pass filter the output signal from the linear position sensor to suppress disturbances from vibration. This low-pass filtering provides a more reliable tool wear indication which is not as affected by the vibration that is normally present during floor grinding.

Since both the floor grinding machine and the concrete surface may be damaged in case the abrasive tools wear out completely, the control unit can be arranged to inactivate the at least one power source in response to detecting excessive tool wear. This function represents an automatic safety shut-down of the machine which is automatically activated before damage occurs due to worn out tools. This is a particularly large advantage in autonomous floor grinding machines, where no operator may be present to abort the floor grinding process.

There are also disclosed herein adhesive elements, kits of parts, control units, methods, computer programs and floor grinding machines associated with the above-mentioned advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIGS. 1A-B illustrate an example floor grinder;

FIG. 2 shows an example tool holder with abrasive tools;

FIG. 3 schematically illustrates an abrasive tool;

FIGS. 4A-E illustrate displacement of a dust skirt during operation;

FIG. 5 shows another example tool holder with an abrasive tool;

FIG. 6 illustrates an example linear position sensor;

FIG. 7 shows an example remote control device;

FIG. 8 illustrates an example user equipment; and

FIGS. 9-11 schematically illustrate example tool wear indicators.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

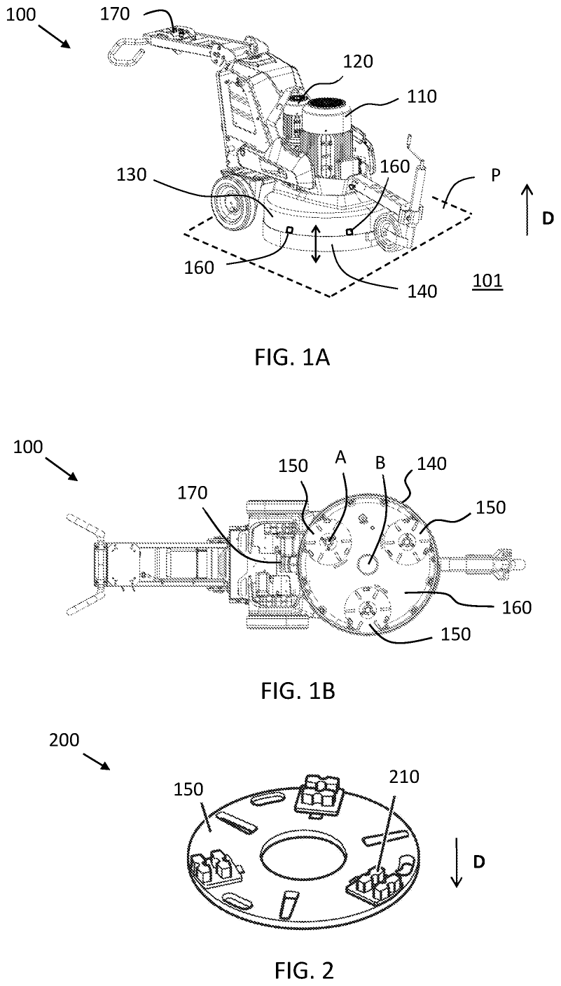

FIGS. 1A and 1B illustrate an example floor grinder 100. The floor grinder 100 comprises a first electric motor 110 arranged to rotatably drive a number of tool holders 150 about respective axes A. Abrasive tools of varying grit and specifications can be mounted onto the tool holders 150. The tool holders 150 on the example machine 100 are comprised on a rotatable body section 160 and arranged in a plane P, which plane P will be essentially parallel to the concrete surface 101 during floor grinding. This body section is often referred to as a planet. A second electric motor 120 is arranged to rotate the planet about a central axis B. The type of drive system shown in FIG. 1 is generally referred to as a planetary drive system.

Electrically powered floor grinders like that illustrated in FIG. 1 are generally known. Floor grinders driven by combustion engines, such as propane-fueled combustion engines, are also known. The techniques and devices disclosed herein are applicable with both electrically powered and combustion engine machines.

The floor grinder 100 comprises a cover body 130 which protects the rotatable body section 160 and the tool holders 150 in particular, or at least forms part of the machine chassis. This cover body may, e.g., be implemented as a plastic or sheet-metal cover. Its main function is to protect the tool holders and the other rotatable parts on the floor grinder from the external environment, and also to prevent the operator from accidentally coming into contact with the rotatable parts during floor grinding. The cover body 130 extends downwards (opposite to the direction indicated by arrow D) towards the plane P, where it terminates in a cover body rim. Thus, the cover body 130 extends towards the concrete surface 101 during floor grinding. The cover body 130, and in particular the cover body rim, normally extends laterally (parallel to the plane P) beyond the lateral extension of the tool holders, i.e., a projection of the cover body 130 and/or cover body rim onto the plane P defines an area which encompasses respective projections of the tool holders onto the same plane P. In this case a projection of the cover body 130 onto the plane P then also defines an area which encompasses a projection of the body section 160 onto the same plane P. The cover body rim may also have a lateral extension (parallel to the plane P) beyond the lateral extension of the tool holders 150, i.e., seen from below as in FIG. 1B the cover body 130 encloses the tool holders 150, thereby separating them from the ambient environment.

Another important function of the cover body 130 is to facilitate dust extraction by means of a dust extractor, often realized as a vacuum device. The cover body at least partly defines a volume which can be accessed via a dust extraction aperture 170, to which the dust extractor can be connected via a hose in a known manner. To improve the efficiency of the dust extraction, a dust skirt 140 is movably attached around the rim of the cover body 130 to engage the concrete surface 101 during floor grinding operation. The dust skirt 140 forms part of the boundary of the volume accessible via a dust extraction aperture 170. The dust skirt 140 is movable in a direction normal to the plane P, such that gravity causes it to be supported on the concrete surface during operation where it seals the volume defined by the cover body. The dust skirt 140 may also be spring-loaded such that it is pressed against the concrete surface 101 during use. This seal prevents dust from escaping from the volume, except via the dust extraction aperture 170. A brush can be mounted onto the dust skirt to improve the seal, or the dust skirt can be formed in a resilient material such as rubber to improve the seal between dust skirt and concrete surface. Cover bodies with dust skirts are generally known and will therefore not be discussed in more detail herein.

The dust skirt 140 may in some cases extend longitudinally (in the direction D) above the tool holders 150, such that the plane P intersects the dust skirt 140 and not the cover body 130. The dust skirt may also taper inwards, i.e., be of a frustoconical shape.

In case the dust skirt is of frustoconical shape, or otherwise tapers inwards, then the cover body 130 does not necessarily need to extend laterally beyond the tool holders, since the tool holders will then be primarily protected by the dust skirt instead of the cover body. A projection of the cover body 130 onto the plane P then defines an area which does not necessarily encompass a projection of the body section 160 onto the plane P. The dust skirt 140, however, has a projection onto the plane P which defines an area that encloses a projection of the body section 160 and the tool holders 150 onto the plane P.

FIG. 2 illustrates an example abrasive tool 200 comprising a tool holder 150 for use with the machine 100. The tool holder 150 in FIG. 2 is equipped with abrasive tools 210 that comprise grinding segments. The tool grinding segments may, e.g., comprise diamond granules or other abrasive particles embedded into a tool segment matrix. An abrasive tool for grinding or polishing is associated with a grit. The grit size indicates the abrasive grade of the tool. A higher grit number indicates a smaller abrasive grain and a finer abrasive product. The terms coarse, medium, and fine are often used in conjunction with grit size of abrasive grains.

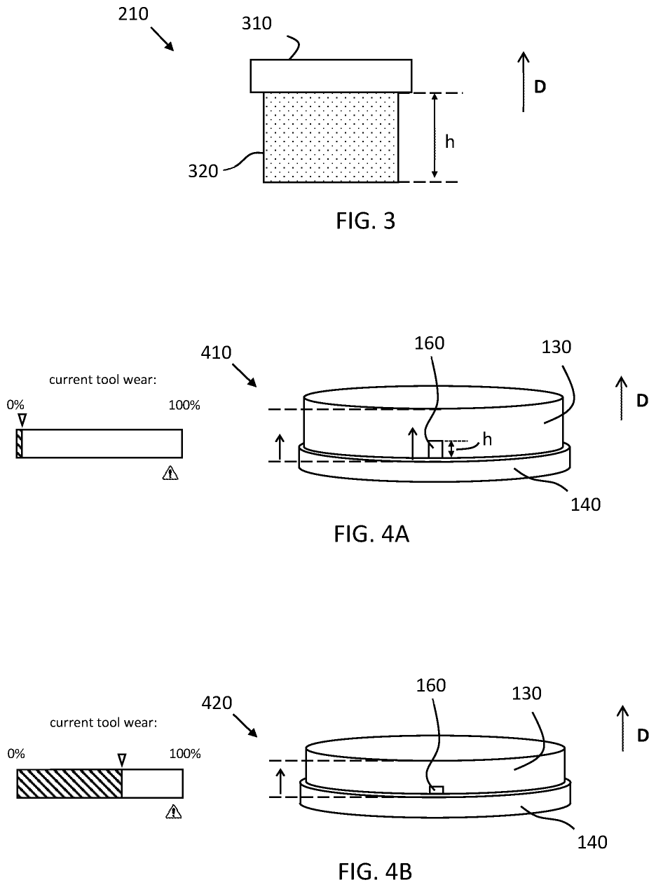

FIG. 3 schematically illustrates an example abrasive tool 210 comprising a base plate 310 or mounting plate, and a grinding segment 320. An abrasive tool is associated with a wear direction, indicated throughout the Figures by direction D. As the tool is worn down, the height h of the grinding segment 320 decreases. As mentioned above, it is important that the abrasive tool is replaced by a new tool before the height h becomes too small. If the base plate 310, which is normally formed in metal or some other hard material, comes into contact with the concrete surface during floor grinding, then the concrete surface and also the machine may be damaged.

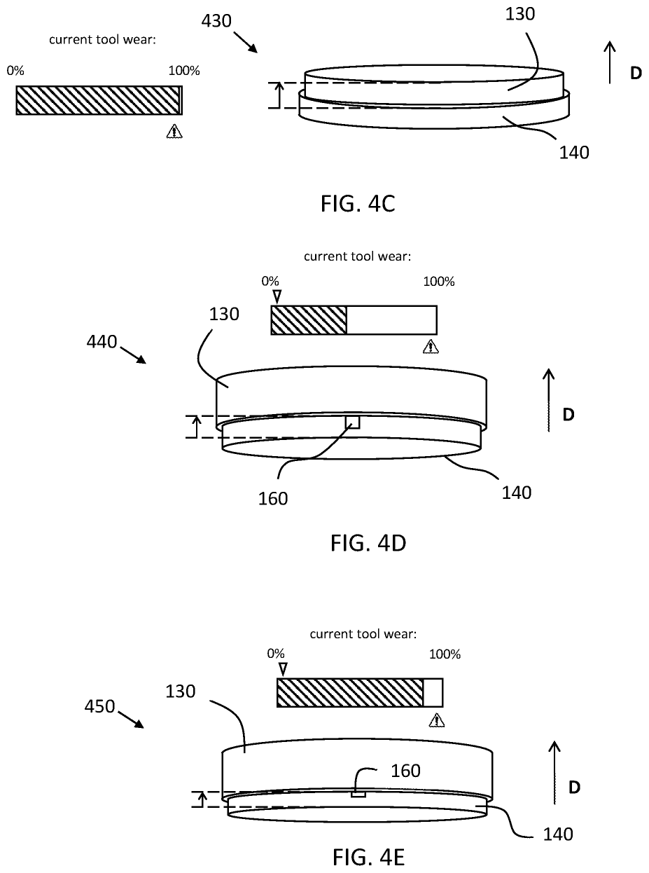

The present disclosure builds on the realization that the dust skirt 140 will move longitudinally, in the wear direction D normal to the plane P, with respect to the cover body 130 as the tool heights h decrease due to tool wear. This is because the cover body is fixedly arranged in relation to the plane P, while the dust skirt is arranged movably in relation to the cover body, such that it is supported by the concrete surface during operation of the floor grinder, where it is held in place by gravity. Thus, a wear indicator 160 can be assembled onto the cover body 130, as shown in FIG. 1A. As the dust skirt slowly traverses in the wear direction D relative to the cover body, this wear indicator 160 will gradually be concealed by the dust skirt 140. A simple sticker can be used as wear indicator, providing a very low complexity means for wear indication. The operator can then inspect the wear indicator without tilting the floor grinder 100, which is an advantage. Of course, as will be discussed below in connection to FIGS. 4D and 4E, the dust skirt can also be arranged on the inside of the cover body, which means that the cover body rim will then gradually traverse along the dust skirt when seen from the outside. In this case the wear indicator can be assembled onto the dust skirt instead of onto the cover body, with the same technical effect of providing wear indication to an operator without requiring the operator to tilt the machine.

To summarize, with reference to FIG. 1, there is disclosed herein a floor grinder 100 for processing a concrete surface 101. The floor grinder comprises one or more rotatable abrasive tool holders 150 arranged in a plane P to hold respective abrasive tools 210. The floor grinder also comprises at least one power source 110, 120 arranged to drive the tool holders 150, and a cover body 130 fixedly arranged in relation to the plane P. The cover body 130 is arranged to form at least part of a barrier between the abrasive tools and the ambient environment during floor grinding. A dust skirt 140 is movably attached around a rim of the cover body 130 to engage the concrete surface 101 during floor grinding operation. This dust skirt moves freely up and down relative to the body cover as the tools are gradually worn down and replaced by new tools, since the distance between the plane P and the concrete surface is determined primarily by the height of the abrasive tool segments—tall fresh grinding segments means that the body cover is further from the concrete surface compared to if the grinding segments are worn out, in which case the tool holders and also the body cover will be closer to the concrete surface. The floor grinder 100 is characterized in that it further comprises at least one tool wear indicator 160 configured to indicate a current tool wear based on a displacement of the dust skirt 140 relative to the cover body 130 in a direction D normal to the plane P. Thus, the relative motion of the dust skirt with respect to the cover body is exploited in order to indicate current tool wear in a convenient manner to an operator, without the operator having to tilt the floor grinder.

One or more tool wear indicators 160 can be arranged on the floor grinder 100, e.g., two, three, four, or any other positive integral number. The advantage with using more than one tool wear indicator is, e.g., that an operator can determine current tool wear from different viewing angles. A plurality of tool wear indicators also provides a degree of redundancy where one or more indicators can fail with no impact to the tool wear indication function. This redundancy effect is also relevant in case the tool wear indicator comprises electronic sensors, as will be discussed below.

As mentioned above, and as illustrated in FIG. 1A, the dust skirt 140 can be mounted external to the cover body 130. The at least one tool wear indicator 160 can then be realized as a visual marker attached to the cover body 130, such as a sticker, where the visual marker is arranged to be traversed and gradually concealed by the dust skirt 140 during displacement of the dust skirt 140 normal to the plane P. FIG. 4A-C exemplify the behavior of the dust skirt 140 during floor grinding when the dust skirt is mounted externally to the cover body 130. In FIG. 4A, a new set of abrasive tools 210 have been mounted onto the tool holders 150. The tool wear indicator 160 has been positioned on the cover body 130. The tool wear indicator 160 may, e.g., simply be a sticker or other adhesive member which is arranged to adhere to the cover body. The sticker can be formed in a dimension which matches that of the grinding segment 320 height h, which means that the operator knows that the tool is spent when the sticker can no longer be seen, since it is concealed by the cover body in its entirety. Alternatively the sticker may comprise a printed marker which indicate when it is time to replace the abrasive tools on the tool holders. FIG. 4B illustrates the tool wear indicator 160 when the tool is worn down about half-way, and FIG. 4C shows a situation where the tool is completely worn down. The abrasive tools need to be replaced before the situation in FIG. 4C occurs, since otherwise there is a risk of damaging the concrete surface and also damaging the floor grinder 100.

The dust skirt 140 can also be mounted internal to the cover body 130. In this case the at least one tool wear indicator 160 may be realized as a visual marker attached to the dust skirt 140 instead of to the cover body, where the visual marker is arranged to be traversed and gradually concealed by the cover body 130 during displacement of the dust skirt 140 normal to the plane P. This alternative configuration is exemplified in FIGS. 4D and 4E, where FIG. 4D shows a case where the abrasive tools are about half worn down, and FIG. 4E shows a case where the abrasive tools are worn down enough to merit tool replacement.

It is appreciated that the FIGS. 4A-E are schematic in nature and not drawn to scale.

The at least one tool wear indicator 160 may be marketed and sold together with the abrasive tools, as a sticker with a height normal to the plane P matched to a corresponding height h of an abrasive segment 320. The operator may then apply the stickers to the cover body or to the dust skirt in connection to tool replacement, thus ensuring that the correct types of stickers are used. The tool wear indicator 160 may also comprise a visual identifier indicative of an abrasive tool type associated with the tool wear indicator 160. For instance, the stickers can be in different colors matching a color of the abrasive tool, or comprise text or other means of identification, enabling the operator to verify that the correct type of tool wear indicator is used. Thus, there is disclosed herein a tool wear indicator 160 comprising an adhesive surface arranged to adhere to a cover body 130 of a floor grinder 100, where the tool wear indicator has a physical dimension matched to a corresponding height h of an abrasive segment 320. The tool wear indicator 160 may be sold separately from the abrasive tools or provided as a kit of parts comprising an abrasive tool 210, 510 and a tool wear indicator 160.

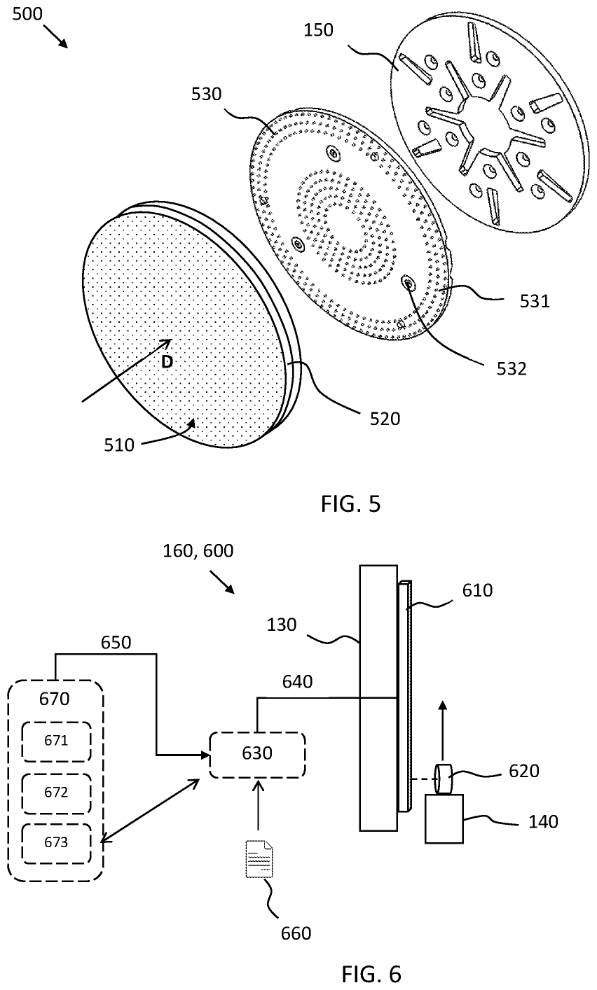

FIG. 5 illustrates a slightly different form factor type of abrasive tool 500 compared to the tool 200 shown in FIG. 2. This type of disc-shaped tool is more commonly seen in polishing applications, but still wears down with use and will be in regular need of replacement. The tool 500 attaches to an intermediary tool holder 530 by a combination of pins 531 and magnets 532. This intermediary tool holder 530 then attaches to a regular tool holder 150. The disc shaped tool 500 has an abrasive section 510 with a thickness 520 corresponding to the height h. As the tool is gradually worn down, the dust skirt will move relative to the cover body, which means that the same type of tool wear indicators can be used also with this type of tool.

Other, more advanced, types of tool wear indicators can also be used based on the same principle of a dust skirt which moves relative to a cover body of the floor grinder as a function of tool wear.

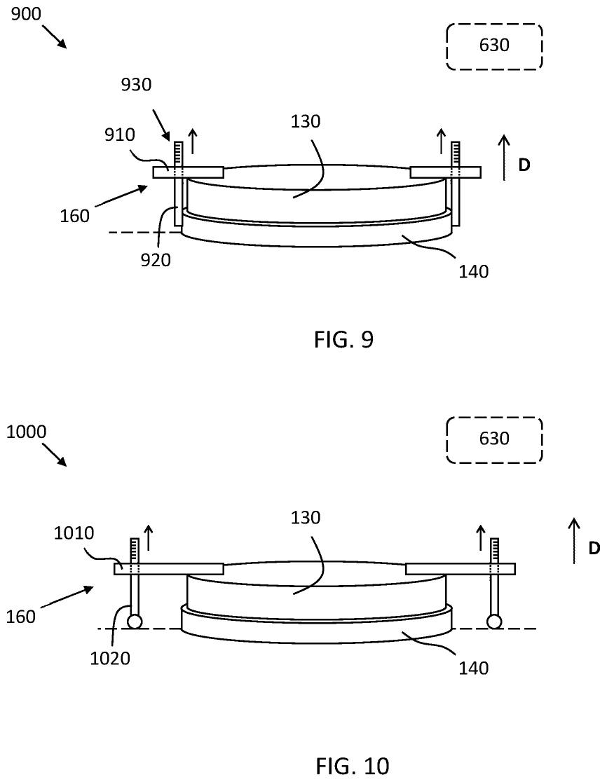

FIG. 9 illustrates another example of a tool wear indicator 160 configured to indicate a current tool wear based on a displacement of the dust skirt 140 relative to the cover body 130 in the direction D normal to the plane. This tool wear indicator 160 comprises a first part 910 fixedly attached to the cover body 130 and a second part 920 fixedly attached to the dust skirt 140. The first part 910 and the second part 920 are slidably arranged with respect to each other in the direction D, such that the current tool wear can be inferred from, e.g., markings 930 on the second part 920 as shown in FIG. 9. The markings may be in the form of a displacement measurement marking, i.e., parallel lines at mm spacing or the like, or some form of tool wear code, such as color markings indicating if the tool wear is within acceptable limits or if the tool wear is such as to warrant tool replacement. A green color can be used to indicate that tool wear is at an acceptable level, a yellow color can be used to indicate that the tool is about to be worn out, and a red color can be used to signal a worn down tool in need of immediate replacement. Such color markings can be made on the second part 920 exiting the first part 910, such that different colors are revealed as the tool wears down and the second part rises up though the first part 910 which slidably holds the second part 920.

Of course, a linear position sensor such as those discussed in connection to FIG. 6 below can also be used to indicate tool wear in this manner. One part of the linear position sensor can then be attached to the first part 910 and the other part of the linear position sensor can be attached to the second part 920. One, two or more arrangements of this type can be used. FIG. 9 illustrates an example with two arrangements.

FIG. 10 illustrates an alternative embodiment 1000 of the techniques disclosed herein, which builds on the same basic principles. In this case the floor grinder 100 comprises at least one tool wear indicator 160 configured to indicate a current tool wear based on a displacement of the cover body 130 relative to the concrete surface 101 in a direction D normal to the plane P. The tool wear indicator in FIG. 10 comprises a first part 1010 fixedly attached to the cover body 130 and a second part 1020 which is supported on the concrete surface, e.g., by a wheel or other supporting member as illustrated in FIG. 10. The first part 1010 and the second part 1020 are slidably arranged with respect to each other in the direction D in a manner similar to the arrangement in FIG. 9, such that the current tool wear can be inferred from, e.g., markings 930 on the second part 920 as shown in FIG. 9. Of course, a linear position sensor such as those discussed in connection to FIG. 6 below can also be used to indicate tool wear in this manner. One part of the linear position sensor can then be attached to the first part 1010 and the other part of the linear position sensor can be attached to the second part 1020. One, two or more arrangements of this type can be used. FIG. 10 illustrates an example with two arrangements.

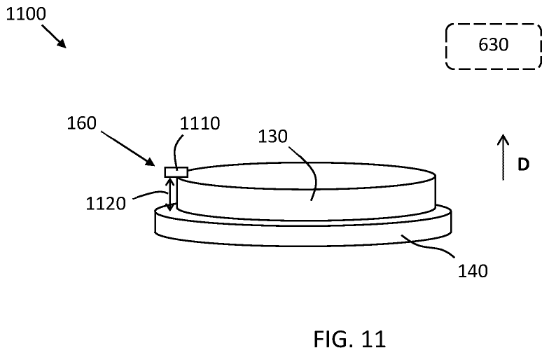

FIG. 11 illustrates yet another example 1100 of a tool wear indicator 160. This tool wear indicator comprises a distance sensor, such as a laser measurement device or an inductance distance sensor 1110 arranged to measure a distance to the dust skirt 140 relative to the cover body 130. This distance can, as explained above, be used to infer tool wear. The arrangement also comprises the control unit 630, as schematically indicated in the Figure.

Any of the tool wear indicators disclosed herein may comprise a magnet allowing the tool wear indicator to be attached to the floor grinder 100 in a convenient manner. For instance, a tool wear indicator such as that illustrated in FIGS. 9-11 can be mounted onto the floor grinder with magnetic attachment means. This allows the tool wear indicator to be assembled with legacy equipment, and it also allows the tool wear indicator to be moved between different machines, including between different types of machines.

Any of the electronic tool wear indicators disclosed herein can be configured to display the tool wear on a display mounted directly onto the tool wear indicator, or send a signal indicative of the measured tool wear to a control unit separate from the tool wear indication. This signal transmission may be an analog or a digital signal. For instance, a Controller Area Network (CAN) message can be used to transmit the tool wear indication information to a control unit separate from the tool wear indicator. This information can then be displayed on a display. FIG. 6 schematically illustrates a tool wear indicator 160, 600 which comprises a linear position sensor 610, 620, i.e., an electronic sensor device. The floor grinder 100 then comprises a control unit 630 arranged to receive an output signal 640 from the linear position sensor 610, 620, from which it is able to infer a current tool wear status. The linear position sensor generally comprises a first part 610 arranged on the cover body 130 and a second part 620 arranged on the dust skirt 140 (or vice versa if the dust skirt instead enters into the cover body interior as in FIG. 4D-E). Several options exist for the realization of this linear position sensor. For instance, the linear position sensor 610, 620 may comprise any of: a capacitive displacement sensor, a Hall effect sensor, and inductive sensor, a linear variable differential transformer, a photodiode array, and a linear mechanical encoder. Each of these sensors are capable of outputting a signal which indicates longitudinal displacement between the first part 610 and the second part 620, either as a differential signal indicating change in linear position or as an absolute signal which indicates the linear position in absolute sense.

Combinations of different types of linear position sensors can also be used with advantage to obtain a more reliable output signal 640. Indeed, the electronic linear position sensors may also be used in combination with the passive visual indicators discussed above, i.e., the stickers. The control unit 630 can then be arranged to determine a current tool wear 840 based on the output signal 640 from the linear position sensor, since the relative position of the first part 610 and the second part 620 depends on the relative positions of the cover body 130 and the dust skirt 140, which is indicative of tool wear, as discussed above. This sensor arrangement for determining tool wear based on a linear position sensor is significantly easier to implement in a reliable and accurate manner compared to previously proposed sensor arrangements for measuring tool wear on concrete processing equipment.

It is appreciated that the floor grinder will vibrate during floor grinding, and the dust skirt is likely to bounce a bit as it moves on the concrete surface. This vibration and transient motion will cause a disturbance in the output signal 640. To account for these disturbances, the control unit 630 may implement an averaging filter or some other form of low-pass filter which suppresses the effects from the vibration and motion due to floor grinding.

According to an example, the control unit 630 is arranged to receive an external reset signal 650, which the operator triggers when a new set of abrasive tools have been fitted to the tool holders 150. The control unit then counts down based on the output signal 640 from the linear position sensor in order to determine current tool wear. In this case there is no need for an absolute linear position fix from the linear position sensor, a relative or differential output signal 640 is sufficient, which is an advantage.

According to another example, the output signal 640 comprises an absolute measurement of linear position. In this case the control unit 630 can determine the remaining height of the abrasive tool without prior calibration or reset by the operator, which is an advantage.

The control unit 630 may also have access to stored tool data 660 indicative of tool dimensions, minimum tool height when replacement must be performed, and so on. This tool data can be used to determine when a tool change is warranted. For instance, the tool data can be used to configure threshold values which can be compared to the current relative displacement between cover body and dust skirt, and thereby used to trigger a warning signal. The control unit 630 may also be arranged to inactivate the floor grinder, or at least to disengage the power sources 110, 120 in case it determines that there is a risk that the tool holder 150 comes into contact with the concrete surface due to excessive tool wear, i.e., the control unit 630 is optionally arranged to inactivate the at least one power source 110, 120 on the floor grinder in response to detecting excessive tool wear. Excessive tool wear may, e.g., be detected if the relative displacement between cover body and dust skirt exceeds a threshold value, which threshold value may be configured in dependence of the current type of tool attached to the floor grinder.

The control unit 630 is optionally also arranged to determine a current tool wear rate based on the output signal 640 from the linear position sensor and on a time reference. The tool wear rate can simply be determined as a time differentiation of the linear position sensor signal and indicates how fast the tool is being worn down. This allows an operator to fine-tune the floor grinding process in order to make it more efficient and also improve the end result. US2017312884, mentioned above, also discusses this possibility. A preferred tool wear rate can be obtained as part of the tool data 660.

The control unit 630 may also determine an estimated time to next tool shift 860 based on the output signal from the linear position sensor and on abrasive tool data 660.

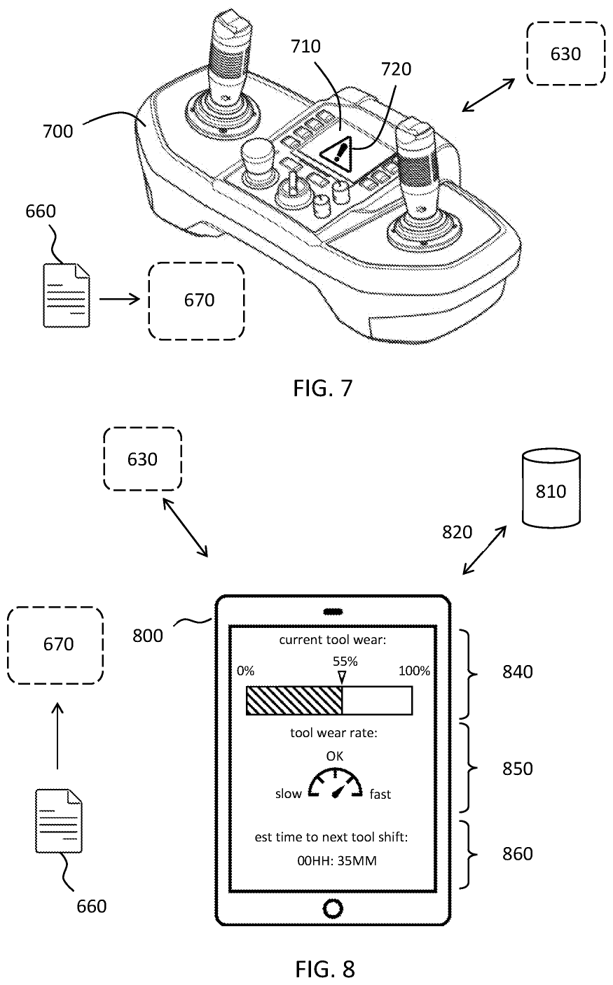

The control unit 630 is preferably connected via wired or wireless link to a control panel 170, 670 or other form of display means accessible by an operator, e.g., on a control panel 170 of the machine 100 located close to the floor grinder handles. FIGS. 7 and 8 illustrate some example control panels 670 arranged for wireless operation.

FIG. 7 shows a remote control device 700 arranged to be connected via wireless link to the floor grinder 100 in order to control its operations. The tool wear indicator data can then be displayed on a display 710 of the remote control device. For instance, the remote control device can be configured to display a warning signal 720 when it is time to replace the abrasive tools, which warning signal can also be accompanied by an audible signal or even a tactile signal, generated by a vibrator.

FIG. 8 shows another form of control panel 670, here a tablet device 800 or smart phone executing various applications related to the data obtained from the tool wear indicator 160 via the linear position sensor 610, 620.

The control panel 670 and/or control unit 630 is optionally connected to a remote server 810 via wireless link 820, from which remote server 810 various configuration data and operating parameters can be obtained. The remote server 810 can also be configured to receive data from the linear position sensor 610, 620, which enables it to form a database of, e.g., tool wear rates and the like from a group of floor grinders.

The control panel 670 can be configured to display data associated with the linear position sensor output signal. For instance, the current tool wear 840, a tool wear rate 850, and/or an estimated time to the next tool change 860.

The current data can be compared to the stored data 660 and/or to data received from the remote server 810 in order to determine if the current operation characteristics are as expected, or if some room for improvement is present. In this case the operator may be notified about this sub-optimal floor grinding and can then change one or more operating parameters in order to improve the floor grinding process.

FIG. 6 also schematically illustrates, in terms of a number of functional units, the general components of the control panel 670. Processing circuitry 671 is provided using any combination of one or more of a suitable central processing unit CPU, multiprocessor, microcontroller, digital signal processor DSP, etc., capable of executing software instructions stored in a computer program product, e.g. in the form of a storage medium 672. The processing circuitry 671 may further be provided as at least one application specific integrated circuit ASIC, or field programmable gate array FPGA.

Particularly, the processing circuitry 671 is configured to cause the floor grinder and/or the control panel to perform a set of operations, or steps, such as the methods discussed above. For example, the storage medium 672 may store the set of operations, and the processing circuitry 671 may be configured to retrieve the set of operations from the storage medium 672 to cause the device to perform the set of operations. The set of operations may be provided as a set of executable instructions. Thus, the processing circuitry 671 is thereby arranged to execute methods as herein disclosed.

The storage medium 672 may also comprise persistent storage, which, for example, can be any single one or combination of magnetic memory module, optical memory module, solid state memory module or even remotely mounted memory module.

The circuit may further comprise an interface 673 for communications with at least one external device. As such the interface 673 may comprise one or more transmitters and receivers, comprising analogue and digital components and a suitable number of ports for wireline or wireless communication.

The processing circuitry 671 controls the general operation of the control panel, e.g., by sending data and control signals to the interface 673 and the storage medium 672, by receiving data and reports from the interface 673, and by retrieving data and instructions from the storage medium 672.

1. A floor grinder for processing a concrete surface, the floor grinder comprising:
one or more rotatable abrasive tool holders arranged in a plane to hold respective abrasive tools,
at least one power source arranged to drive the tool holders,
a cover body fixedly arranged in relation to the plane, and
a dust skirt movably attached around a rim of the cover body to engage the concrete surface during floor grinding operation,
wherein the floor grinder comprises at least one tool wear indicator configured to indicate a current tool wear based on a displacement of the dust skirt relative to the cover body in a direction normal to the plane.

2. The floor grinder according to claim 1, wherein the dust skirt is external to the cover body, wherein the at least one tool wear indicator is a visual marker attached to the cover body, wherein the visual marker is arranged to be traversed and gradually concealed by the dust skirt during displacement of the dust skirt normal to the plane.

3. The floor grinder according to claim 1, wherein the dust skirt is internal to the cover body, wherein the at least one tool wear indicator is a visual marker attached to the dust skirt, wherein the visual marker is arranged to be traversed and gradually concealed by the cover body during displacement of the dust skirt normal to the plane.

4. The floor grinder according to claim 1, wherein the at least one tool wear indicator is a sticker with a height normal to the plane matched to a corresponding height of an abrasive segment.

5. The floor grinder according to claim 4, wherein the at least one tool wear indicator comprises a visual identifier indicative of an abrasive tool type associated with the at least one tool wear indicator.

6. The floor grinder according to claim 1, wherein the at least one tool wear indicator comprises a linear position sensor, and wherein the floor grinder comprises a control unit arranged to receive an output signal from the linear position sensor, and to determine a current tool wear based on the output signal from the linear position sensor.

7. The floor grinder according to claim 6, wherein the linear position sensor is any of: a capacitive displacement sensor, a Hall effect sensor, and inductive sensor, a linear variable differential transformer, a photodiode array, and a linear mechanical encoder.

8. The floor grinder according to claim 6, wherein the linear position sensor comprises a distance sensor arranged to measure a distance to the dust skirt relative to the cover body.

9. The floor grinder according to claim 6, wherein the position sensor is configured to output a differential position output signal, and wherein the control unit is arranged to receive a reset signal, and to determine a tool wear based on the differential position output signal and on the reset signal.

10. The floor grinder according to claim 6, wherein the position sensor is configured to output an absolute position output signal, and wherein the control unit is arranged to determine a tool wear based on the absolute position output signal.

11. The floor grinder according to claim 6, wherein the control unit is arranged to determine a current tool wear rate based on the output signal from the linear position sensor and on a time reference, or
wherein the control unit is arranged to determine an estimated time to next tool shift based on the output signal from the linear position sensor and on abrasive tool data.

12. (canceled)

13. The floor grinder according to claim 6, wherein the control unit is arranged to average, or low-pass filter the output signal from the linear position sensor to suppress disturbances from vibration, or
wherein the control unit is arranged to inactivate the at least one power source in response to detecting excessive tool wear.

14. (canceled)

15. The floor grinder according to claim 1, wherein the dust skirt is arranged to be biased in direction of the concrete surface during use.

16. The floor grinder according to claim 15, where the dust skirt is spring loaded in direction of the concrete surface during use.

17. The floor grinder according to claim 1, wherein the dust skirt is movably attached around the rim of the cover body to permit: relative rotation of the cover body and dust skirt about a central axis, or relative movement of the cover body and dust skirt in a direction normal to the plane along a central axis.

18. (canceled)

19. The floor grinder according to claim 1, wherein the dust skirt is movably attached around the rim of the cover body to permit relative movement of the cover body and dust skirt in a direction normal to the plane, to prevent relative rotation of the cover body and dust skirt about a central axis normal to the plane.

20. The floor grinder according to claim 1, wherein the tool wear indicator comprises a magnet configured to hold the tool wear indicator in position relative to the cover body or the dust skirt by engaging a magnetic component on the cover body or the dust skirt.

21. A tool wear indicator comprising an adhesive surface arranged to adhere to a cover body of a floor grinder, wherein the tool wear indicator has a physical dimension matched to a corresponding height of an abrasive segment.

22. (canceled)

23. A floor grinder for processing a concrete surface, the floor grinder comprising:
one or more rotatable abrasive tool holders arranged in a plane to hold respective abrasive tools,
at least one power source arranged to drive the tool holders, and
a cover body fixedly arranged in relation to the plane,
wherein the floor grinder comprises at least one tool wear indicator configured to indicate a current tool wear based on a displacement of the cover body relative to the concrete surface in a direction normal to the plane.

24. The floor grinder according to claim 23, wherein the displacement of the cover body relative to the concrete surface is indicated by a displacement of the cover body in relation to at least one other part of the floor grinder.
